(19) United States
(12) Patent Application Publication
(10) Pub. No.: US 2025/0131248 A1
(43) Pub. Date: Apr. 24, 2025

(54) EFFICIENT MULTIPLICATION APPROXIMATION FOR ARTIFICIAL INTELLIGENT (AI) ENGINES

(71) Applicant: QUALCOMM Incorporated, San Diego, CA (US)

(72) Inventors: Jihad MASRI, Mississauga (CA); Gregory SMITH, Etobicoke (CA); Venkata Ravi Kiran DAYANA, San Diego, CA (US); Eric Wayne MAHURIN, Austin, TX (US)

(21) Appl. No.: 18/493,649

(22) Filed: Oct. 24, 2023

(51) Int. Cl. G06N 3/0464; G06N 3/09

(52) U.S. Cl. CPC G06N 3/0464; G06N 3/09

(57) ABSTRACT

A processor-implemented method for multiplication approximation includes receiving inputs to be processed using an artificial intelligence (AI) compute engine. The inputs have a first precision. The AI compute engine is configured for processing in a second precision different from the first precision. A first parameter for the inputs and a second parameter for the AI compute engine are defined. The first parameter and the second parameter respectively indicate a first portion of the first precision and a second portion of the second precision to use for computation by the AI compute engine. The inputs and the second set of compute engine parameters are respectively adapted according to the first parameter and the second parameter to generate a first representation and a second representation. An approximation of an AI workload for the inputs is generated based on the first representation and the second representation.

### FIELD OF THE DISCLOSURE

Aspects of the present disclosure generally relate to efficient multiplication approximation for artificial intelligent (AI) engines.

### BACKGROUND

Artificial neural networks may comprise interconnected groups of artificial neurons (e.g., neuron models). The artificial neural network (ANN) may be a computational device or be represented as a method to be performed by a computational device. Convolutional neural networks (CNNs) are a type of feed-forward ANN. Convolutional neural networks may include collections of neurons that each have a receptive field and that collectively tile an input space. Convolutional neural networks, such as deep convolutional neural networks (DCNs), have numerous applications. In particular, these neural network architectures are used in various technologies, such as image recognition, speech recognition, acoustic scene classification, keyword spotting, autonomous driving, and other classification tasks.

Because of the many useful applications for neural network architectures, many hardware and software applications have been developed to streamline processing of artificial intelligence workloads. Such devices and applications may implement a standard data format such as Institute for Electrical and Electronic Engineers (IEEE) 8-bit, 16-bit, 32-bit, or 64-bit format. However, in some instances the input precision may not align with the hardware or software applications (e.g., 10- or 12-bit input or activations). Thus, performing computations such as convolution operations may be challenging and expensive.

### SUMMARY

In some aspects of the present disclosure, a processor-implemented method includes receiving inputs to be processed using an artificial intelligence (AI) compute engine. The inputs have a first precision and the AI compute engine is configured for processing in a second precision that is different from the first precision. The processor-implemented method also includes defining a first parameter for the inputs and a second parameter for the AI compute engine. The first parameter indicates a first portion of the first precision to use for computations by the AI compute engine and the second parameter indicates a second portion of the second precision to use for computation by the AI compute engine. The processor-implemented method additionally includes adapting the inputs according to the first parameter to generate a first representation of the inputs and a second set of compute engine parameters according to the second parameter to generate a second representation of the second set of compute engine parameters. The processor-implemented method further includes generating an approximation of an AI workload for the inputs based on the first representation and the second representation.

Another aspect of the present disclosure is directed to an apparatus including means for receiving inputs to be processed using an artificial intelligence (AI) compute engine. The inputs have a first precision and the AI compute engine is configured for processing in a second precision that is different from the first precision. The apparatus also includes means for defining a first parameter for the inputs and a second parameter for the AI compute engine. The first parameter indicates a first portion of the first precision to use for computations by the AI compute engine and the second parameter indicates a second portion of the second precision to use for computation by the AI compute engine. The apparatus additionally includes means for adapting the inputs according to the first parameter to generate a first representation of the inputs and a second set of compute engine parameters according to the second parameter to generate a second representation of the second set of compute engine parameters. The apparatus further includes means for generating an approximation of an AI workload for the inputs based on the first representation and the second representation.

In another aspect of the present disclosure, a non-transitory computer-readable medium with non-transitory program code recorded thereon is disclosed. The program code is executed by a processor and includes program code to receive inputs to be processed using an artificial intelligence (AI) compute engine. The inputs have a first precision and the AI compute engine is configured for processing in a second precision that is different from the first precision. The program code also includes program code to define a first parameter for the inputs and a second parameter for the AI compute engine. The first parameter indicates a first portion of the first precision to use for computations by the AI compute engine and the second parameter indicates a second portion of the second precision to use for computation by the AI compute engine. The program code additionally includes program code to adapt the inputs according to the first parameter to generate a first representation of the inputs and a second set of compute engine parameters according to the second parameter to generate a second representation of the second set of compute engine parameters. The program code further includes program code to generate an approximation of an AI workload for the inputs based on the first representation and the second representation.

Another aspect of the present disclosure is directed to an apparatus having at least one memory and one or more processors coupled to the at least one memory. The processor(s) is configured to receive inputs to be processed using an artificial intelligence (AI) compute engine. The inputs have a first precision and the AI compute engine is configured for processing in a second precision that is different from the first precision. The processor(s) is also configured to define a first parameter for the inputs and a second parameter for the AI compute engine. The first parameter indicates a first portion of the first precision to use for computations by the AI compute engine and the second parameter indicates a second portion of the second precision to use for computation by the AI compute engine. The processor(s) is additionally configured to adapt the inputs according to the first parameter to generate a first representation of the inputs and a second set of compute engine parameters according to the second parameter to generate a second representation of the second set of compute engine parameters. The processor(s) is further configured to generate an approximation of an AI workload for the inputs based on the first representation and the second representation.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that may modularize artificial intelligence (AI) functions, in accordance with aspects of the present disclosure.

FIG. 5 is a table illustrating examples of representations of operands, in accordance with various aspects of the present disclosure.

FIG. 6 is a diagram illustrating example code for generating expressions for the multiplication approximation, in accordance with various aspects of the present disclosure.

FIG. 7 is a block diagram illustrating an example multiply accumulate (MAC) unit, in accordance with various aspects of the present disclosure.

FIG. 8A is a block diagram illustrating a conventional multiplication approximation approach.

FIG. 8B is a block diagram illustrating an example multiplication approximation, in accordance with various aspects of the present disclosure.

FIG. 8C is a block diagram illustrating the weight expansion block of FIG. 8B, in accordance with various aspects of the present disclosure.

FIG. 9 is a flow diagram illustrating a processor-implemented method for multiplication approximation, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described, in some instances input precision may not align with hardware or software applications (e.g., 10- or 12-bit input or activations). For instance, input precisions may not be aligned to compute unit precisions for a first layer in neural networks. As a result, precise computations under such circumstances may be challenging and costly. This is because artificial intelligence workloads may involve convolution or multiplication operations.

Some conventional approaches for addressing the misaligned input and compute precisions attempt to correct the alignment. For instance, inputs may be aligned to a common higher precision, for example, place 10-bit activation in 16-bit containers. Another conventional approach attempts to align the inputs to a lower precision and externally compose the data, for example, by partitioning activations into most significant bit (MSB), and least significant bit (LSB), and then shifting-and-summing externally. Other conventional approaches utilize specialized hardware to handle such cases, potentially increasing design complexity, area, and power.

Accordingly, to address these and other challenges, aspects of the present disclosure are directed to multiplication approximation for artificial intelligence (AI) computation devices. In various aspects, a convolution operation may also be approximated or represented with an activation having per-channel precisions (e.g., 8-bit, or 10-bit precision). In some aspects, convolutions including 10-bit or 12-bit activations and 8-bit weights may be approximated efficiently using 8-bit-activations, or 8-bit weight convolution engines.

Particular aspects of the subject matter described in this disclosure can be implemented to realize one or more of the following potential advantages. In some examples, the described techniques may beneficially provide an additional trade-off control point between network accuracy, power, latency, and bandwidth to increase spectrum utilization. Further advantages may include increased accuracy, and reduced latency and power consumption.

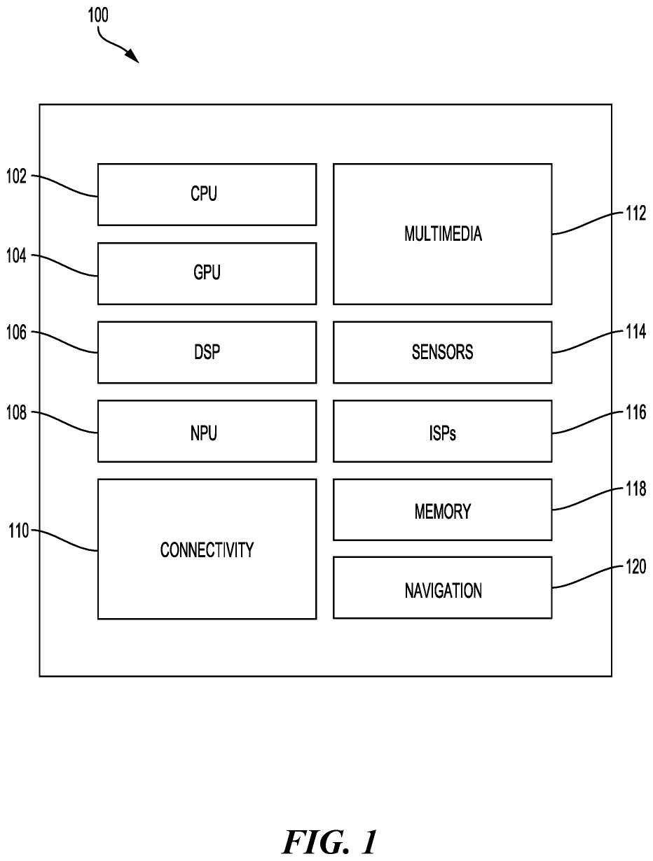

FIG. 1 illustrates an example implementation of a system-on-a-chip (SOC) 100, which may include a central processing unit (CPU) 102 or a multi-core CPU configured for multiplication approximation. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM, RISC-V, or any reduced instruction set computing (RISC) architecture. In aspects of the present disclosure, the instructions loaded into the general-purpose processor 102 may include code to receive inputs to be processed using an artificial intelligence (AI) compute engine. The inputs have a first precision. The AI compute engine may be configured for processing in a second precision, different from the first precision. The instructions loaded into the general-purpose processor 102 may also include code to define a first parameter for the inputs and a second parameter for the AI compute engine. The first parameter indicates a first portion of the first precision to use for computations by the AI compute engine and the second parameter indicates a second portion of the second precision to use for computation by the AI compute engine. The instructions loaded into the general-purpose processor 102 may additionally include code to adapt the inputs according to the first parameter to generate a first representation of the inputs and a second set of compute engine parameters according to the second parameter to generate a second representation of the second set of compute engine parameters. The instructions loaded into the general-purpose processor 102 may also include code to generate an approximation of an AI workload for the inputs based on the first representation and the second representation.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

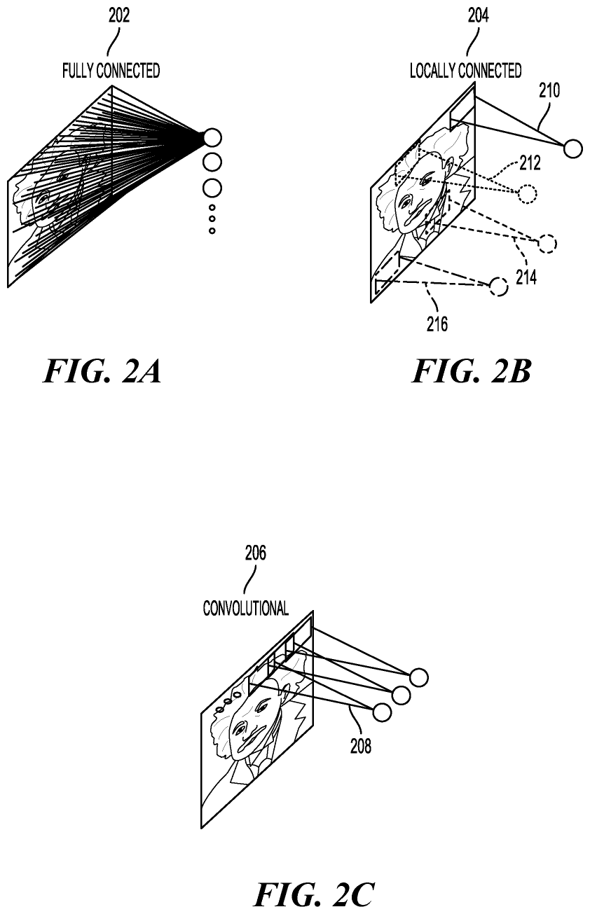

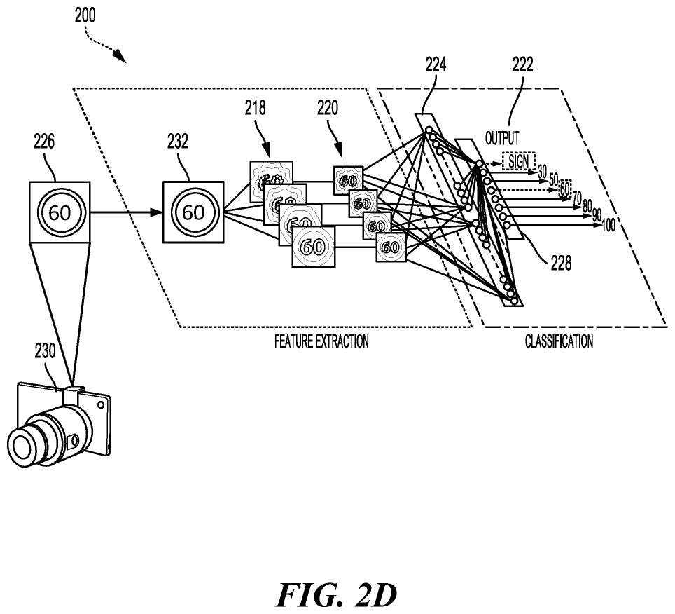

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

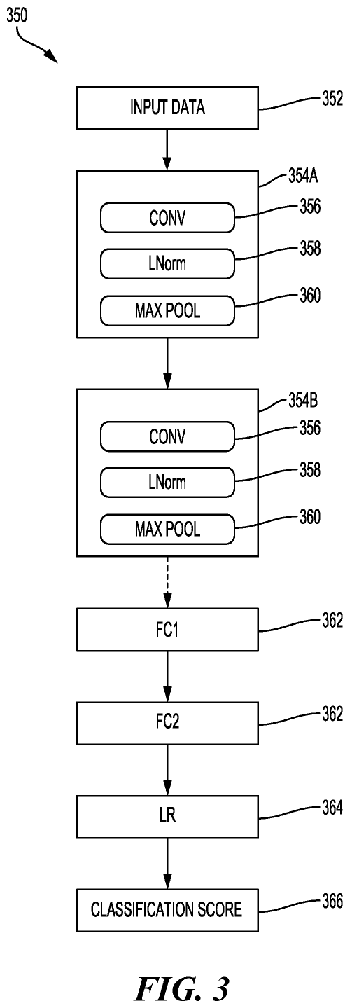

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

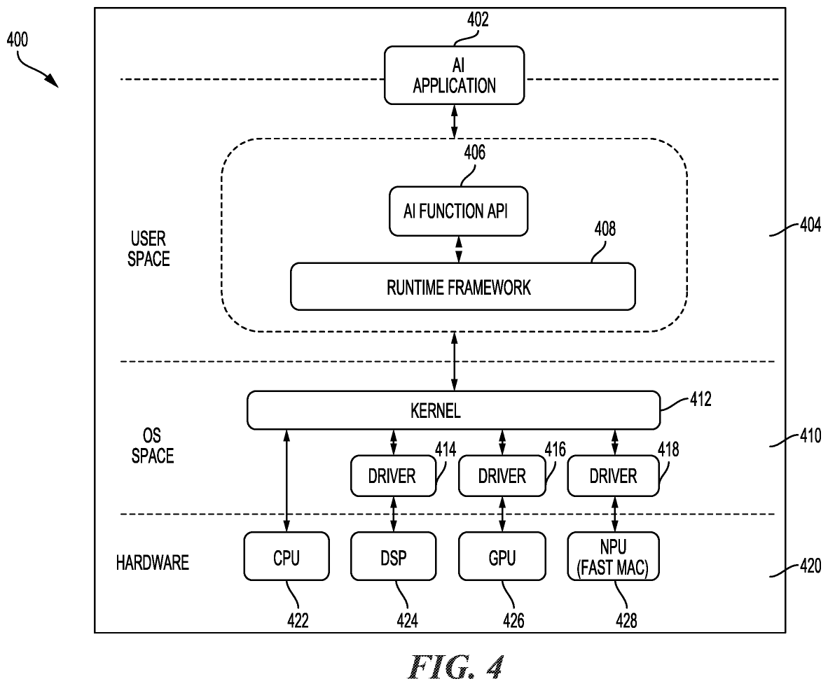

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SoC 100 of FIG. 1) to support multiplication approximation for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compile program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to multiplication approximation for inputs having a precision that is misaligned with AI computation units.

Computations that utilize multiplications may have a known, static precision of the operands. For example, an artificial neural network may have a network description that defines a precision on activations and weights, for instance, which maps to two multiplication operands within convolution computations. The known precisions of two operands that may be multiplied may be defined as A_prec and B_prec. For instance, the precisions may include information defined for tensors in TensorFlow-graphs.

In various aspects of the present disclosure, additional parameters may be defined for representing the two operands. An operand A representation parameter (A_sp) may be defined as a list of integers describing a partitioning of the digits of the operand A. In some aspects, the list of integers describing a partitioning of the digits of the operand A may sum to the number of digits in the precision of operand A (A_prec). An operand B representation parameter (B_cp) may be defined as a list of precisions of operand B where each entry is the precision of B to use with the corresponding partition in A created by a given A_sp entry. In some aspects, the list of precisions of operand B may have a same size as the operand A representation parameter (A_sp). Unlike the operand precisions (e.g., A_prec, B_prec), which characterize the inputs of a multiplication operation, the representation parameters (e.g., A_sp and B_cp) may characterize the multiplication operation.

By adaptively representing the operands (e.g., operand A and operand B) based on the representation parameters, multiplication operations of a neural network may be approximated according to a tradeoff between accuracy and power consumption latency and bandwidth.

In some aspects, rounding may also be applied to the representations to further reduce the approximation error. For instance, the compute engine parameters may be rounded to a desired cross-precision.

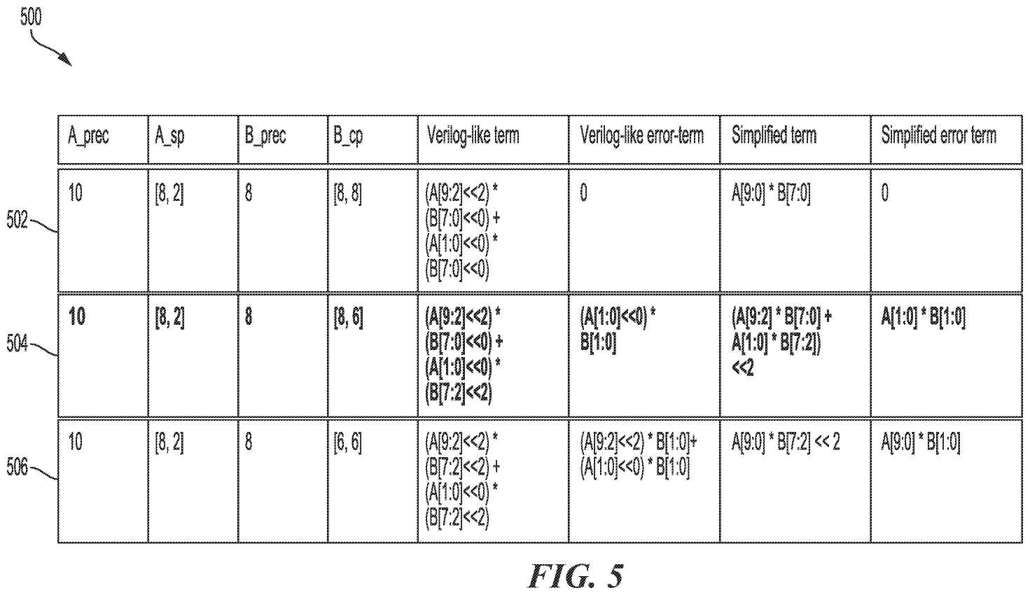

FIG. 5 is a table 500 illustrating examples of representations of operands, in accordance with various aspects of the present disclosure. Referring to FIG. 5, in an example 502, an input (operand A) may have a precision of 10. On the other hand, a set of compute engine parameters (operand B) (e.g., weights or activations) may have a precision of eight. For instance, the compute engine may include an eight-bit multiply accumulate (MAC) unit. In one example, the input may be a ten-bit camera input. In another example, the input may comprise a YUV camera input (e.g., ten-bit luma (Y) and eight-bit chroma projection (UV)).

A representation parameter of operand A (e.g., A_sp) may be defined as [8, 2] to indicate that the input may be partitioned to include eight bits in one partition and two bits in the other partition. For instance, the eight bits may correspond to the most significant bits of the input (operand A) and two bits may correspond to the least significant bits of the input. The representation parameter of the operand B (e.g., B_cp) may be defined as [8, 8] to indicate that all eight bits of the eight-bit precision compute engine parameters may be used to represent the compute engine parameters.

In the example 502, the representation parameters may be applied to the respective operands to compute a multiplication approximation. In doing so, the eight most significant bits of the input may be multiplied by the eight bits of the compute engine parameters (e.g., weights or activations) and added to the product of the two least significant bits of the input and the eight bits of the compute engine parameters. Because all of the bits of operand A and operand B are used in the multiplication operation of example 502, the approximation error may be zero.

On the other hand, in an example 504, the operand B parameter (B_cp) may be defined as [8, 6] to indicate that eight bits or six bits of the eight-bit precision may represent the compute engine parameters (e.g., weights or activations). For example, the six bits of the compute engine parameters may be the six most significant bits or the least significant bits of the compute engine parameters. However, it should be understood that any six of the bits precision compute engine parameters may be used for the multiplication approximation according to the acceptable approximation error, for instance.

In the example 504, the eight most significant bits of the input may be multiplied by all eight bits of the compute parameters. However, only six of the eight bits may be multiplied with the two least significant bits of the input.

In an example 506, the operand B parameter (B_cp) may be defined as [6, 6] to indicate that six bits of the eight-bit precision for the compute engine parameters (e.g., weights or activations) may represent the compute engine parameters (e.g., weights or activations). For example, the six bits of the compute engine parameters may be the six most significant bits or the least significant bits of the compute engine parameters or another set of six-bits of the eight-bit precision. Accordingly, in the example 506, the eight most significant bits of the input may be multiplied by a six-bit portion (e.g., most significant bit or least significant bit) of the eight-bit precision of the compute engine parameters and summed with the product of the two least significant bits of the input multiplied by the six-bit portion to generate the multiplication approximation.

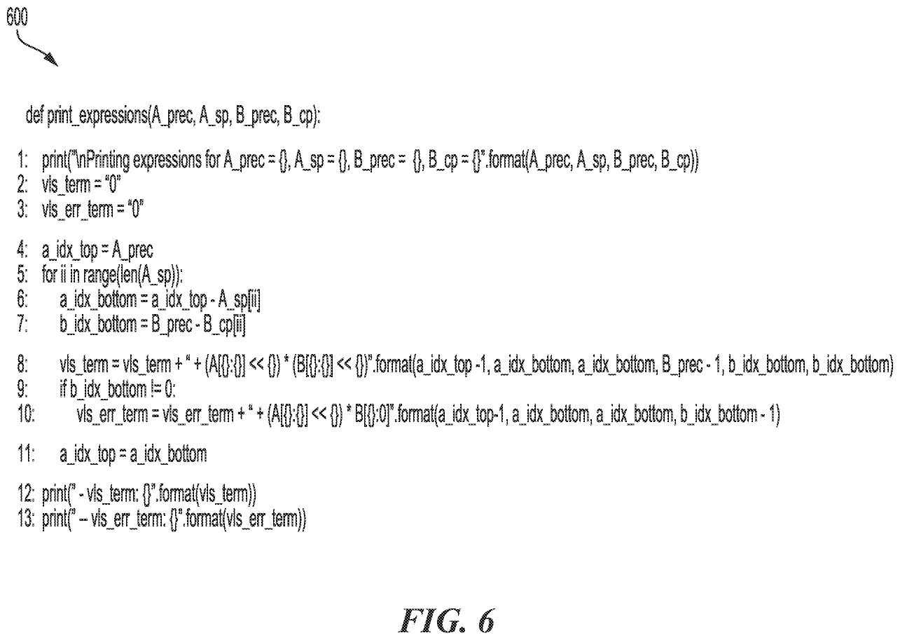

FIG. 6 is a diagram illustrating example code 600 for generating expressions for the multiplication approximation, in accordance with various aspects of the present disclosure. Referring to FIG. 6, at line 1, the representation parameters for operand A (A_sp) and operand B (B_cp) may be defined for the known precisions of the operand A (A_prec) and operand B (B_prec). At lines 5-7, the operand A may be partitioned and represented based on the defined representation parameter (A_sp). Operand B may be represented based on the representation parameter (B_cp). At lines 8-10, a set of operations may be generated to approximate the multiplication of operand A and operand B based on the respective representation of operand A and operand B.

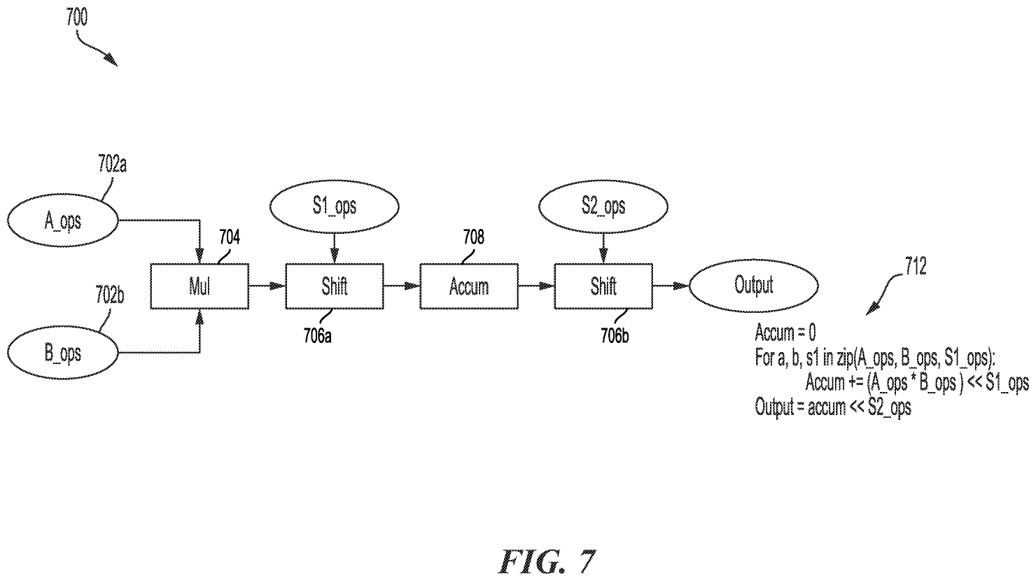

FIG. 7 is a block diagram illustrating an example multiply accumulate (MAC) unit 700, in accordance with various aspects of the present disclosure. Referring to FIG. 7, the MAC unit 700 may receive as inputs an operand A (A_ops) 702a (e.g., an input) and an operand B (B_ops) 702b (e.g., weights or activations). The MAC unit 700 may include a multiplier 704 and shift units 706a, 706b. The multiplier may be configured to perform a multiplication operation on the inputs. For instance, the multiplier 704 may perform multiply 8-bit operands (e.g., 8*8 bit multiplication), and the shift units 706a, 706b may implement the partitioning of the operands (702a, 702b) into 8-bit numbers. That is, shift units 706a, 706b may be configured to shift in bits for a multiplication operation based on the determined partitions specified according to the value of corresponding shift operands S1_ops and S2_ops to accumulate, using accumulator 708, the product of multiplier 704 and generate an output.

In various aspects, the MAC unit 700 may be operated according to example pseudocode 712, for instance. In some aspects, when the shift operand S1_ops has a value of 0 (e.g., no partitioning), a shift of A_ops 702a may not be performed and in such cases, the MAC unit 700 may operate without the shift unit 706a.

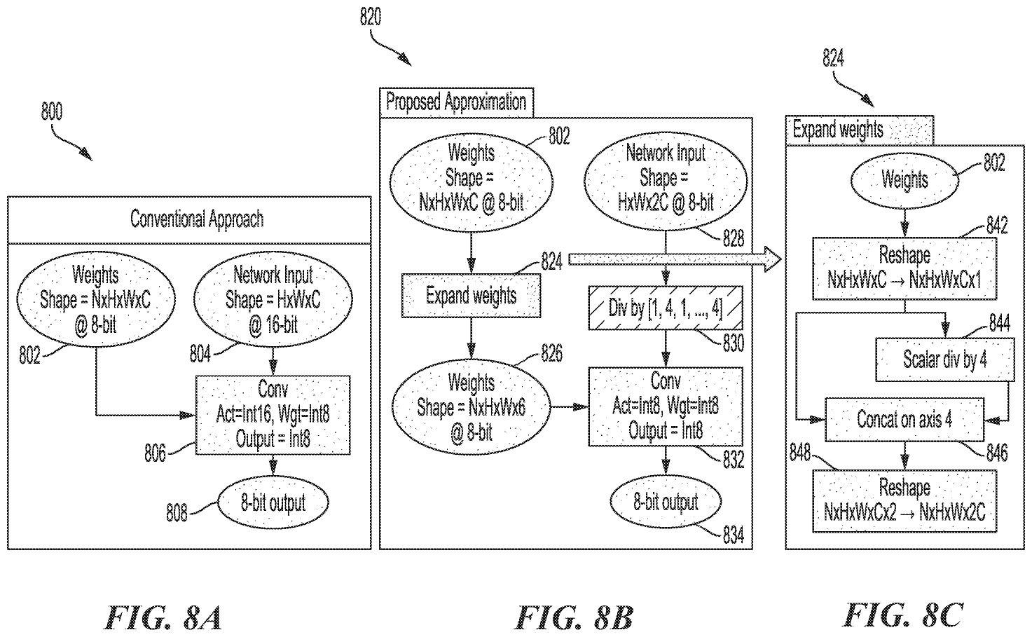

FIG. 8A is a block diagram illustrating a conventional multiplication approximation approach 800. Referring to FIG. 8A, the conventional multiplication approximation approach 800 may receive a network input 804. The network input 804 may be a 16-bit input having the shape H×W×C, where H is the height, W is the width, and C is the channel. The conventional multiplication approximation approach may aim to apply a set of weights 802 to the network input 804. However, the weights 802 may have an eight-bit precision with a shape N×H×W×C. To approximate a convolution operation 806, the conventional multiplication approximation approach 800 may truncate the network input 804, retaining the eight most significant bits and convolve the truncated network input 804 with the weights 802 to generate an eight-bit output 808.

FIG. 8B is a block diagram illustrating an example multiplication approximation 820, in accordance with various aspects of the present disclosure. In the example approximation 820, a network input 828 may be partitioned using the representation parameter (e.g., A_sp). Accordingly, the network input 828 may have the shape H×W×2C, where each channel is an eight-bit partition. A shift block 830 may shift the value of the respective channels of the input when the input precision is misaligned with the precision of the compute engine (e.g., input 10- or 12-bit precision). The weights 802 may be expanded via an expansion block 824 and convolved with the eight-bit partitions in a convolution block 832 to generate an eight-bit output 834.

FIG. 8C is a block diagram illustrating an example weight expansion block 824 of FIG. 8B, in accordance with various aspects of the present disclosure. The expansion block 824 may convert the weights 802 (e.g., for the more precise computation) to enable the example approximation 820. The weight expansion block receives the weights 802 as input. A reshape operation (842) is performed on the weights to adapt the dimensions of the weights 802 from N×H×W×C to N×H×W×C×1 to produce reshaped weights. A scalar division operation (844) may also be performed. In the example weight expansion block 824, the scalar division operation divides the reshaped weights by four. However, the present disclosure is not so limiting and the divisor may be any value according to design preference, for instance. The scalar division (844) by four may shift the bits of the reshaped weights to the right by four places as a dividend. In turn, the resulting dividend may be subject to a concatenation operation (846) on the adapted dimension (e.g., axis 4). In this way, a container (848) for the weights (or activation inputs) may be reshaped or increased (e.g., 10-bit activation input may be included in a larger container (e.g., 16-bit container).

The operations of the example weight expansion block 824 may be statically computed at compile-time. Accordingly, the example expansion block 824 may enable matching the precision of inputs and outputs for convolution operations such as may be performed via convolution block 832, for instance.

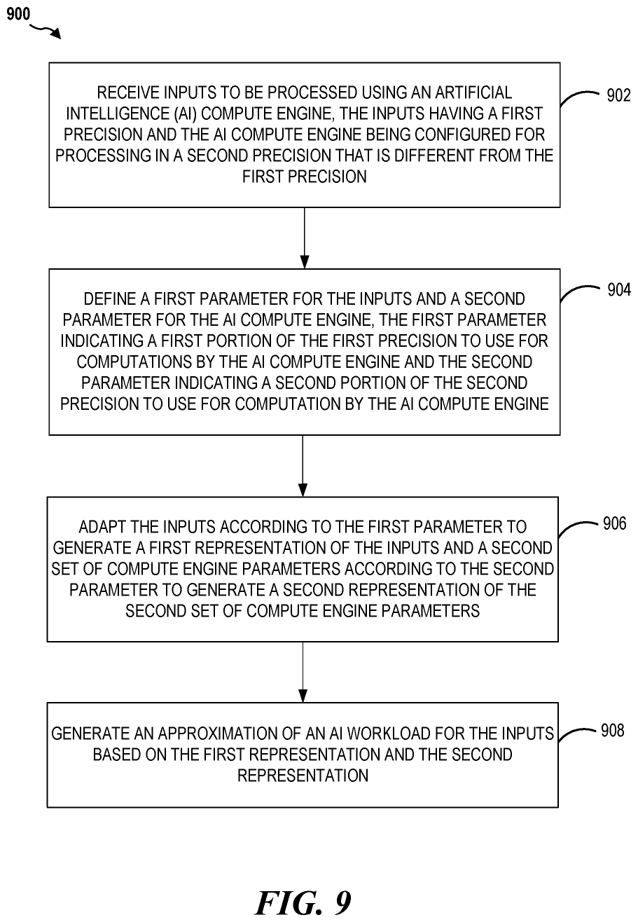

FIG. 9 is a flow diagram illustrating a processor-implemented method 900 for multiplication approximation, in accordance with various aspects of the present disclosure. The processor-implemented method 900 may be performed by a processor such as the CPU (e.g., 102, 322), the GPU (e.g., 104, 326), and/or other processing units (e.g., DSP 324 or NPU 328), for example.

As shown in FIG. 9, at block 902, the processor receives inputs to be processed using an artificial intelligence (AI) compute engine. The inputs have a first precision and the AI compute engine is configured for processing in a second precision that is different from the first precision. As described, for example, with reference to FIG. 5, in an example 502, an input (operand A) may have a precision of 10. On the other hand, a set of compute engine parameters (operand B) (e.g., weights or activations) may have a precision of eight. For instance, the compute engine may include an eight-bit multiply accumulate (MAC) unit. In one example, the input may be a ten-bit camera input. In another example, the input may comprise a YUV camera input (e.g., ten-bit luma (Y) and eight-bit chroma projection (UV)).

At block 904, the processor defines a first parameter for the inputs and a second parameter for the AI compute engine. The first parameter indicates a first portion of the first precision to use for computations by the AI compute engine and the second parameter indicates a second portion of the second precision to use for computation by the AI compute engine. For instance, as described with reference to FIG. 5, a representation parameter of operand A (e.g., A_sp) may be defined as [8, 2] to indicate that the input may be partitioned to include eight bits in one partition and two bits in the other partition. A representation parameter of the operand B (e.g., B_cp) may be defined as [8, 8] to indicate that all eight bits of the eight-bit precision compute engine parameters may be used to represent the compute engine parameters.

At block 906, the processor adapts the inputs according to the first parameter to generate a first representation of the inputs and a second set of compute engine parameters according to the second parameter to generate a second representation of the second set of compute engine parameters. As described, for example, with reference to FIG. 5, the representation parameters may be applied to the respective operands to compute a multiplication approximation. In doing so, the eight most significant bits of the input may be multiplied by the eight bits of the compute engine parameters (e.g., weights or activations) and added to the product of the two least significant bits of the input and the eight bits of the compute engine parameters.

On the other hand, in an example 504, the operand B parameter (B_cp) may be defined as [8, 6] to indicate that eight bits or six bits of the eight-bit precision may represent the compute engine parameters (e.g., weights or activations). For example, the six bits of the compute engine parameters may be the six most significant bits or the least significant bits of the compute engine parameters.

At block 908, the processor generates an approximation of an AI workload for the inputs based on the first representation and the second representation. For example, as described, by adaptively representing the operands (e.g., operand A and operand B) based on the representation parameters, multiplication operations of a neural network may be approximated according to a tradeoff between accuracy and power consumption latency and bandwidth.

Implementation examples are included in the following numbered clauses.

1. An apparatus comprising:
at least one memory; and
at least one processor coupled to the at least one memory, the at least one processor configured to:
   receive inputs to be processed using an artificial intelligence (AI) compute engine, the inputs having a first precision and the AI compute engine being configured for processing in a second precision that is different from the first precision;
   define a first parameter for the inputs and a second parameter for the AI compute engine, the first parameter indicating a first portion of the first precision to use for computations by the AI compute engine and the second parameter indicating a second portion of the second precision to use for computation by the AI compute engine;
   adapt the inputs according to the first parameter to generate a first representation of the inputs and a second set of compute engine parameters according to the second parameter to generate a second representation of the second set of compute engine parameters; and
   generate an approximation of an AI workload corresponding to the inputs based on the first representation and the second representation.

2. The apparatus of clause 1, in which the first precision is greater than the second precision.

3. The apparatus of clause 1 or 2, in which the first parameter specifies a first number of bits of the inputs having the first precision to use for computations by the AI compute engine and the second parameter specifies a second number of bits of the compute engine parameters having the second precision to use for computations by the AI compute engine.

4. The apparatus of any of clauses 1-3, in which the at least one processor is further configured to truncate the inputs based on the first parameter to generate the first representation.

5. The apparatus of any of clauses 1-4, which the at least one processor is further configured to adaptively select one of most significant bits or least significant bits for each of the first representation and the second representation based on the first parameter and the second parameter, respectively.

6. The apparatus of any of clauses 1-5, in which the at least one processor is further configured to round one or more of the inputs based on the first parameter or the compute engine parameters based on the second parameter.

7. The apparatus of any of clauses 1-6, in which the compute engine parameters comprise one or more of weights or activations.

8. The apparatus of any of clauses 1-7, in which the at least one processor is further configured to define a third parameter defining a third number of times a summation operation is repeated to generate the approximation.

9. A processor-implemented method performed by at least one processor, the processor-implemented method comprising:
receiving inputs to be processed using an artificial intelligence (AI) compute engine, the inputs having a first precision and the AI compute engine being configured for processing in a second precision that is different from the first precision;
defining a first parameter for the inputs and a second parameter for the AI compute engine, the first parameter indicating a first portion of the first precision to use for computations by the AI compute engine and the second parameter indicating a second portion of the second precision to use for computation by the AI compute engine;
adapting the inputs according to the first parameter to generate a first representation of the inputs and a second set of compute engine parameters according to the second parameter to generate a second representation of the second set of compute engine parameters; and
generating an approximation of an AI workload for the inputs based on the first representation and the second representation.

10. The processor-implemented method of clause 9, in which the first precision is greater than the second precision.

11. The processor-implemented method of clause 9 or 10, in which the first parameter specifies a first number of bits of the inputs having the first precision to use for computations by the AI compute engine and the second parameter specifies a second number of bits of the compute engine parameters having the second precision to use for computations by the AI compute engine.

12. The processor-implemented method of any of clauses 9-11, further comprising truncating the inputs based on the first parameter to generate the first representation.

13. The processor-implemented method of any of clauses 9-12, further comprising adaptively selecting one of most significant bits or least significant bits for each of the first representation and the second representation based on the first parameter and the second parameter, respectively.

14. The processor-implemented method of any of clauses 9-13, further comprising rounding one or more of the inputs based on the first parameter or the compute engine parameters based on the second parameter.

15. The processor-implemented method of any of clauses 9-14, in which the compute engine parameters comprise one or more of weights or activations.

16. The processor-implemented method of any of clauses 9-15, further comprising defining a third parameter defining a third number of times a summation operation is repeated to generate the approximation.

17. A non-transitory computer-readable medium having program code recorded thereon, the program code executed by a processor and comprising:
program code to receive inputs to be processed using an artificial intelligence (AI) compute engine, the inputs having a first precision and the AI compute engine being configured for processing in a second precision that is different from the first precision;
program code to define a first parameter for the inputs and a second parameter for the AI compute engine, the first parameter indicating a first portion of the first precision to use for computations by the AI compute engine and the second parameter indicating a second portion of the second precision to use for computation by the AI compute engine;
program code to adapt the inputs according to the first parameter to generate a first representation of the inputs and a second set of compute engine parameters according to the second parameter to generate a second representation of the second set of compute engine parameters; and
program code to generate an approximation of an AI workload for the inputs based on the first representation and the second representation.

18. The non-transitory computer-readable medium of clause 17, in which the first precision is greater than the second precision.

19. The non-transitory computer-readable medium of clause 17 or 18, in which the first parameter specifies a first number of bits of the inputs having the first precision to use for computations by the AI compute engine and the second parameter specifies a second number of bits of the compute engine parameters having the second precision to use for computations by the AI compute engine.

20. The non-transitory computer-readable medium of any of clauses 17-19, in which the program code comprises program code to truncate the inputs based on the first parameter to generate the first representation.

21. The non-transitory computer-readable medium of any of clauses 17-20, in which the program code comprises program code to adaptively select one of most significant bits or least significant bits for each of the first representation and the second representation based on the first parameter and the second parameter, respectively.

22. The non-transitory computer-readable medium of any of clauses 17-21, in which the program code comprises program code to round one or more of the inputs based on the first parameter or the compute engine parameters based on the second parameter.

23. The non-transitory computer-readable medium of any of clauses 17-22, in which the compute engine parameters comprise one or more of weights or activations.

24. The non-transitory computer-readable medium of any of clauses 17-23, in which the program code comprises program code to define a third parameter defining a third number of times a summation operation is repeated to generate the approximation.

25. An apparatus, comprising:
means for receiving inputs to be processed using an artificial intelligence (AI) compute engine, the inputs having a first precision and the AI compute engine being configured for processing in a second precision that is different from the first precision;
means for defining a first parameter for the inputs and a second parameter for the AI compute engine, the first parameter indicating a first portion of the first precision to use for computations by the AI compute engine and the second parameter indicating a second portion of the second precision to use for computation by the AI compute engine;
means for adapting the inputs according to the first parameter to generate a first representation of the inputs and a second set of compute engine parameters according to the second parameter to generate a second representation of the second set of compute engine parameters; and
means for generating an approximation of an AI workload for the inputs based on the first representation and the second representation.

26. The apparatus of clause 25, in which the first parameter specifies a first number of bits of the inputs having the first precision to use for computations by the AI compute engine and the second parameter specifies a second number of bits of the compute engine parameters having the second precision to use for computations by the AI compute engine.

27. The apparatus of clause 25 or 26, further comprising means for truncating the inputs based on the first parameter to generate the first representation.

28. The apparatus of any of clauses 25-27, further comprising means for adaptively selecting one of most significant bits or least significant bits for each of the first representation and the second representation based on the first parameter and the second parameter, respectively.

29. The apparatus of any of clauses 25-28, further comprising means for rounding one or more of the inputs based on the first parameter or the compute engine parameters based on the second parameter.

30. The apparatus of any of clauses 25-29, further comprising means for defining a third parameter indicating a third number of times a summation operation is repeated to generate the approximation.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. An apparatus comprising:
at least one memory; and
at least one processor coupled to the at least one memory, the at least one processor configured to:
receive inputs to be processed using an artificial intelligence (AI) compute engine, the inputs having a first precision and the AI compute engine being configured for processing in a second precision that is different from the first precision;
define a first parameter for the inputs and a second parameter for the AI compute engine, the first parameter indicating a first portion of the first precision to use for computations by the AI compute engine and the second parameter indicating a second portion of the second precision to use for computation by the AI compute engine;
adapt the inputs according to the first parameter to generate a first representation of the inputs and a second set of compute engine parameters according to the second parameter to generate a second representation of the second set of compute engine parameters; and
generate an approximation of an AI workload corresponding to the inputs based on the first representation and the second representation.

2. The apparatus of claim 1, in which the first precision is greater than the second precision.

3. The apparatus of claim 1, in which the first parameter specifies a first number of bits of the inputs having the first precision to use for computations by the AI compute engine and the second parameter specifies a second number of bits of the compute engine parameters having the second precision to use for computations by the AI compute engine.

4. The apparatus of claim 1, in which the at least one processor is further configured to truncate the inputs based on the first parameter to generate the first representation.

5. The apparatus of claim 1, which the at least one processor is further configured to adaptively select one of most significant bits or least significant bits for each of the first representation and the second representation based on the first parameter and the second parameter, respectively.

6. The apparatus of claim 1, in which the at least one processor is further configured to round one or more of the inputs based on the first parameter or the compute engine parameters based on the second parameter.

7. The apparatus of claim 1, in which the compute engine parameters comprise one or more of weights or activations.

8. The apparatus of claim 1, in which the at least one processor is further configured to define a third parameter defining a third number of times a summation operation is repeated to generate the approximation.

9. A processor-implemented method performed by at least one processor, the processor-implemented method comprising:
receiving inputs to be processed using an artificial intelligence (AI) compute engine, the inputs having a first precision and the AI compute engine being configured for processing in a second precision that is different from the first precision;
defining a first parameter for the inputs and a second parameter for the AI compute engine, the first parameter indicating a first portion of the first precision to use for computations by the AI compute engine and the second parameter indicating a second portion of the second precision to use for computation by the AI compute engine;
adapting the inputs according to the first parameter to generate a first representation of the inputs and a second set of compute engine parameters according to the second parameter to generate a second representation of the second set of compute engine parameters; and
generating an approximation of an AI workload for the inputs based on the first representation and the second representation.

10. The processor-implemented method of claim 9, in which the first precision is greater than the second precision.

11. The processor-implemented method of claim 9, in which the first parameter specifies a first number of bits of the inputs having the first precision to use for computations by the AI compute engine and the second parameter specifies a second number of bits of the compute engine parameters having the second precision to use for computations by the AI compute engine.

12. The processor-implemented method of claim 9, further comprising truncating the inputs based on the first parameter to generate the first representation.

13. The processor-implemented method of claim 9, further comprising adaptively selecting one of most significant bits or least significant bits for each of the first representation and the second representation based on the first parameter and the second parameter, respectively.

14. The processor-implemented method of claim 9, further comprising rounding one or more of the inputs based on the first parameter or the compute engine parameters based on the second parameter.

15. The processor-implemented method of claim 9, in which the compute engine parameters comprise one or more of weights or activations.

16. The processor-implemented method of claim 9, further comprising defining a third parameter defining a third number of times a summation operation is repeated to generate the approximation.

17. A non-transitory computer-readable medium having program code recorded thereon, the program code executed by a processor and comprising:
program code to receive inputs to be processed using an artificial intelligence (AI) compute engine, the inputs having a first precision and the AI compute engine being configured for processing in a second precision that is different from the first precision;
program code to define a first parameter for the inputs and a second parameter for the AI compute engine, the first parameter indicating a first portion of the first precision to use for computations by the AI compute engine and the second parameter indicating a second portion of the second precision to use for computation by the AI compute engine;
program code to adapt the inputs according to the first parameter to generate a first representation of the inputs and a second set of compute engine parameters according to the second parameter to generate a second representation of the second set of compute engine parameters; and
program code to generate an approximation of an AI workload for the inputs based on the first representation and the second representation.

18. The non-transitory computer-readable medium of claim 17, in which the first precision is greater than the second precision.

19. The non-transitory computer-readable medium of claim 17, in which the first parameter specifies a first number of bits of the inputs having the first precision to use for computations by the AI compute engine and the second parameter specifies a second number of bits of the compute engine parameters having the second precision to use for computations by the AI compute engine.

20. The non-transitory computer-readable medium of claim 17, in which the program code comprises program code to truncate the inputs based on the first parameter to generate the first representation.

21. The non-transitory computer-readable medium of claim 17, in which the program code comprises program code to adaptively select one of most significant bits or least significant bits for each of the first representation and the second representation based on the first parameter and the second parameter, respectively.

22. The non-transitory computer-readable medium of claim 17, in which the program code comprises program code to round one or more of the inputs based on the first parameter or the compute engine parameters based on the second parameter.

23. The non-transitory computer-readable medium of claim 17, in which the compute engine parameters comprise one or more of weights or activations.

24. The non-transitory computer-readable medium of claim 17, in which the program code comprises program code to define a third parameter defining a third number of times a summation operation is repeated to generate the approximation.

25. An apparatus, comprising:
means for receiving inputs to be processed using an artificial intelligence (AI) compute engine, the inputs having a first precision and the AI compute engine being configured for processing in a second precision that is different from the first precision;
means for defining a first parameter for the inputs and a second parameter for the AI compute engine, the first parameter indicating a first portion of the first precision to use for computations by the AI compute engine and the second parameter indicating a second portion of the second precision to use for computation by the AI compute engine;
means for adapting the inputs according to the first parameter to generate a first representation of the inputs and a second set of compute engine parameters according to the second parameter to generate a second representation of the second set of compute engine parameters; and
means for generating an approximation of an AI workload for the inputs based on the first representation and the second representation.

26. The apparatus of claim 25, in which the first parameter specifies a first number of bits of the inputs having the first precision to use for computations by the AI compute engine and the second parameter specifies a second number of bits of the compute engine parameters having the second precision to use for computations by the AI compute engine.

27. The apparatus of claim 25, further comprising means for truncating the inputs based on the first parameter to generate the first representation.

28. The apparatus of claim 25, further comprising means for adaptively selecting one of most significant bits or least significant bits for each of the first representation and the second representation based on the first parameter and the second parameter, respectively.

29. The apparatus of claim 25, further comprising means for rounding one or more of the inputs based on the first parameter or the compute engine parameters based on the second parameter.

30. The apparatus of claim 25, further comprising means for defining a third parameter indicating a third number of times a summation operation is repeated to generate the approximation.
